(19) United States
(12) Patent Application Publication
(10) Pub. No.: US 2005/0012717 A1
(43) Pub. Date: Jan. 20, 2005

(54) Input device for computer system

(76) Inventor: Cheol-Woo Park, Kwangyangsi (KR)

Correspondence Address: HARNESS, DICKEY & PIERCE, P.L.C., P.O. BOX 828, BLOOMFIELD HILLS, MI, 48303, US

(21) Appl. No.: 10/501,038

(22) PCT Filed: Jan. 7, 2003
(86) PCT No.: PCT/KR03/00019

(30) Foreign Application Priority Data
Jan. 11, 2002 (KR) 10-2002-0001837
Jun. 7, 2002 (KR) 10-2002-0032011

(51) Int. Cl. G09G 5/08

(52) U.S. Cl. 345/163

(57) ABSTRACT

Disclosed herein is an input device for a computer system. The input system having a mouse with a plurality of pointers and a keyboard includes one or more activation selecting portions, a generation selecting portion, a position detecting portion and a driver. The activation selecting portions activate at least one of the pointers of the mouse. The generation selecting portion select the generation of at least one pointer. The position detecting portion is mounted on a side of the mouse to detect movement of the mouse. The driver activates and generates the pointer in response to the selection of the activation selecting portions and the generation selecting portion, respectively, and controls the movement of the pointer in response to detection results output from the position detecting portion.

### TECHNICAL FIELD

The present invention relates generally to an input device for a computer system, and more particularly to an input device for a computer system, which is capable of reducing a moving distance of a mouse, so operating time and a physical exertion to a user are reduced, thus improving operating efficiency and user's convenience.

### PRIOR ART

In general, a mouse for use in conjunction with a computer system is an input device that directly or indirectly controls a computer using a picture output to a monitor of the computer system, in other words coordinates shown on a display. This mouse is used to move a cursor or an icon displayed on a monitor in conjunction with a computer system, select and execute each program, and execute a graphic program and the like. Additionally, this mouse is an input device that is indispensable for the use of a Windows operating system and the Internet and provides a convenient interface to users.

A conventional mouse includes a mouse body, a coordinate recognizing unit formed in the center of the lower portion of the mouse body to recognize the coordinates of a pointer using a ball or light, a selection button for selecting and executing an object or unit of a program using the recognized coordinates, and a menu button.

At the time of using such a conventional mouse, if a mouse body laid on the flat surface of a desk is moved with the hand, an arrow- or a cross-shaped pointer displayed on a monitor is moved according to coordinates detected by the coordinate recognition unit. At this time, after the pointer is located on a program, an icon or one of various units of a computer game desired to be executed, a command is selected or executed by clicking a right or left button, dragging the mouse body while clicking a right button, or double clicking a right button.

However, in the conventional mouse, since all the above-described operations are selected and executed by a single pointer displayed on a monitor, the pointer of the mouse has to be move frequently and relatively long distance.

Accordingly, the conventional mouse is inconvenient in that the mouse has to be frequently moved or dragged so as to stop the pointer of the mouse at a desired location on a monitor. The frequent movement and dragging operations of the mouse may fatigue the hand and wrist of a user.

For example, the operations of the conventional mouse are frequently performed at the times of performing a computer game and searching the Internet, and the frequently movement and dragging operations of the mouse are required to designate a mouse pointer at an appropriate position on a monitor. In particular, when a user cannot find desired information after passing though a plurality of Web sites or servers using a hyperlink function at the time of searching the Internet for information, it is frequently necessary to return to an initial or previous page by selecting a “back” button on a screen Accordingly, in order to perform the above-described operations, the movement of a pointer is frequently performed and the magnitude of the movement is great. As a result, the inconvenience of repeatedly moving the mouse vertically and horizontally is caused to locate a poier at a correct position.

Additionally, in order to select or drag units appearing in a computer game at the time of performing the computer game, the frequent movement and dragging operation of a mouse are required, so the movement and operation of the mouse is inconvenient and a physical exertion is caused.

In order to solve the above-described problems, Korean Pat Unexamined Publication No. 2001-19175 discloses a first conventional scheme in which a plurality of mouse pointers are displayed on a monitor and one of the mouse pointers is activated to be used. In this patent, an additional pointer designation button is provided, a first pointer is activated by clicking the pointer designation button one time, a second pointer is activated by clicking the pointer designation button one more time, and each of the pointers is moved within an area allocated to the pointer. Accordingly, this patent aims at reducing the moving distance of a mouse by preventing the pointer from moving to the other area allocated to the other pointer.

However, in this patent, a work area and a tool area are previously set, so the area of the pointer and the position of the pointer cannot be set as desired by a user. Additionally, in the case where an operation is performed near the border between the work and tool areas, the pointer allocated to the tool area may be closer to the operational area than the pointer allocated to the work area is. In this case, the pointer allocated to the tool area cannot be moved to the work area, so the pointer, allocated to the work area and situated further from the border than the pointer allocated to the tool area is, has to be moved to perform the operation. Therefore, the use of plural pointers has no practical benefit.

Furthermore, when this patent is applied to the Internet, the pointer is located in the tool area of a Web browser, so it is enough to move the pointer within the tool area at the time of selecting a button on the tool area. However, it is impossible to prevent the pointer from moving to a particular button, so the inconvenience of repeatedly moving the mouse vertically and horizontally is caused to locate the pointer at a correct position at the time of selecting the particular button.

Meanwhile, Korean Pat. Appl. No. 1994-39777 discloses a second conventional scheme in which a plurality of mouse pointers are displayed on a monitor, and the mouse pointers are allocated to a plurality of work windows or applications, respectively. In this patent, a user can smoothly move between the windows or applications. However, a single pointer is allocated to a single window or application, so there are not achieved any effects of reducing the moving distance of the mouse and the fatigue of the user.

### DISCLOSURE OF THE INVENTION

Accordingly, the present invention has been made keeping in mind the above problems occurring in the prior art, and an object of the present invention is to provide an input device for a computer system, which is capable of reducing a moving distance of a mouse, so operating time and a physical exertion to a user are reduced, thus improving operating efficiency and user's convenience.

In order to accomplish the above object, the present invention provides an input device for a computer system, the input system having a mouse with a plurality of pointers and a keyboard, comprising one or more activation selecting portions for activating at least one of the pointers of the mouse; a generation selecting portion for selecting generation of at least one pointer, a position detecting portion mounted on a side of the mouse to detect movement of the mouse; and a driver for activating and generating the pointer in response to selection of the activation selecting portions and the generation selecting portion, respectively, and controlling movement of the pointer in response to detection results output from the position detecting portion.

Preferably, the input device may further comprise a hold selecting portion for preventing movement of the selected pointer and enabling selection of an object at which the selected pointer is located.

Preferably, as the mouse is moved, a plurality of pointers generated by the generation selecting portion may be moved together.

Preferably, the driver may transmit signals from the mouse to the computer system and from the computer system to the mouse, and may comprises a memory for storing information on a position of each pointer, a calculation module for calculating a current position of each pointer using the information on the position of each pointer stored in the memory and detection results provided by the position detecting portion, and a control module for retrieving information on a position of a pointer selected by the activation selection portions, the generation selecting portion and the hold selecting portion from the memory, providing the information on the position of the pointer to the calculation module, and providing calculation results obtained by the calculation module to the computer system.

Preferably, the activation selecting portions may comprise first and second activation buttons that each function to activate selected one of the pointers and are formed on a portion of atop of the mouse.

Preferably, the calculation module may calculate a current position of a pointer selected by one of the first and second activation buttons and provide information on the calculated current position to the computer system.

In addition, the present invention provides an input device for a computer system, the input system having a mouse with a plurality of pointers and a keyboard, comprising one or more activation selecting portions for activating at least one of the pointers of the mouse; a hold selecting portion for preventing movement of a selected pointer and enabling selection of an object at which the selected pointer is located; a position detecting portion mounted on a side of the mouse to detect movement of the mouse; and a driver for activating and generating the pointer in response to selection of the activation selecting portions and the generation selecting portion, respectively, and controlling movement of the pointer in response to detection results output from the position detecting portion.

Preferably, if the mouse is moved with the generation selecting portion being pressed, the pointer held by selection of the hold selecting portion is moved along a moving path of the mouse; if the generation selecting portion is released from a pressed state, the held pointer is re-held at a position where the releasing occurs; and remaining pointers except for the held pointer are not moved while the mouse is moved with the generation selecting portion being pressed.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a perspective view of a mouse in accordance with the present invention;

FIG. 2 is a diagram of a configuration of a computer system including the mouse of FIG. 1 in accordance with the present invention;

FIG. 3 is a view of a picture of a Web browser to which the mouse of FIG. 1 is applied; and

FIG. 4 is a view of a picture of a computer aided design program to which the mouse of FIG. 1 is applied.

### BEST MODES FOR CARRYING OUT THE INVENTION

Reference now should be made to the drawings, in which the same reference numerals are used throughout the different drawings to designate the same or similar components.

An input device for a computer system according to the present invention includes a mouse and a keyboard. In order to use the mouse, a driver, which transmits signals from the mouse to the computer system and from the computer system to the mouse, must be mounted on the computer system.

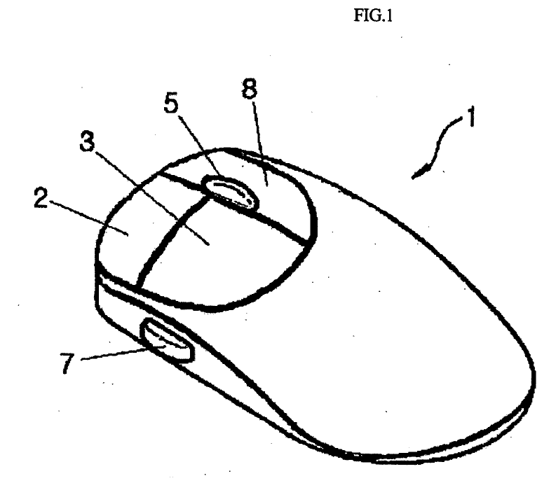

As illustrated in FIG. 1, a mouse 1 of the present invention includes two activation buttons 2 and 3 that are activation selecting portions for activating at least one of plural pointers, a generation button 7 that is a generation selecting portion for selecting the generation of at least one pointer, a holding button 5 that is a hold selecting portion for preventing the movement of a selected one of the plural pointers and enabling the selection of an object at which the selected pointer is located, and a position detecting portion 9 mounted on a side of the mouse 1 to detect the movement of the mouse 1.

The activation buttons 2 and 3 are formed on the left portion of the front of the mouse 1, and perform the function of the selection button of a conventional mouse as well. These activation buttons 2 and 3 comprise first and second activation buttons 2 and 3 that each function to activate a selected pointer. The first and second activation buttons 2 and 3 are separated to the front and back of the top of the mouse 1, respectively. Furthermore, the first and second activation buttons 2 and 3 are formed to be different in height In this embodiment, the first activation button 2 is formed to be higher than the second activation button 3. The reason why the first and second activation buttons 2 and 3 are formed to be different in height is to prevent either of the activation buttons 2 and 3 from being erroneously clicked.

The menu button 8 is formed on the right portion of the front of the mouse 1, that is, to the right of the second activation button 3, like that of a conventional mouse. The holding button 5 having a function into which wheel and button functions for scrolling a picture are integrated is formed between the second activation button 3 and the menu button 8. The holding button 5 is operated by the clicking of the user. The position of a selected pointer is held by clicking the holding button 5, and an object at which the held pointer is located can be selected. That is, when an activation button is clicked while the pointer selected by the holding button 5 is located on a particular function icon, the pointer is not activated but the particular function icon is selected, thus executing the function of the particular function icon. All the pointers may be simultaneously inactivated and activated by the holding button 5. For example, all the pointers may be inactivated by clicking the holding button 5 two times, and activated by clicking the holding button 5 two more times. Alternatively, all the pointers may be inactivated and activated by the combination of the buttons of the mouse or one or more keys of a keyboard.

When all the pointers are activated, all the pointers are moved together as the mouse 1 is moved. In this case, when the mouse 1 is moved to the top of a screen, the mouse 1 can move until a pointer at a highest position reaches the top edge of the screen Similarly, when the mouse 1 is moved to the bottom, right and left of the screen, the mouse 1 can move until pointers at the lowest, rightmost and leftmost positions reach the bottom edge, right edge and left edge of the screen, respectively.

In the meantime, the generation button 7 is formed to be protruded from the left side of the mouse 1. A process of generating a pointer using the generation button 7 is described below. When a computer system is turned on, a single pointer is basically generated, which is referred to as an initial pointer or a first pointer. The mouse 1 is moved to a position where a pointer is desired to be generated, by clicking the generation button 7 after the first pointer is generated. In this case, the first pointer is not moved, but only the moving path of the mouse 1 is displayed on the monitor of the computer system. When the mouse 1 reaches a desired position along a moving path of the mouse 1, a user releases the generation button 7 from a clicked state. At this time, a new pointer is formed at the position that the mouse 1 has reached. In the above-described manner, a plurality of pointers may be generated.

The first and second of generated pointers function as pointers that correspond to the first and second activation buttons 2 and 3, respectively. That is, as the mouse 1 is moved, the first pointer is moved. When the first activation button 2 is clicked, an object at which the first activation button 2 is located is selected, and performs its function. When the second activation button 3 is clicked after the first pointer is activated, the second pointer may be controlled. An object at which the second pointer is located is selected and performs its function in the same way as the fist pointer is controlled.

In this case, the first and second activation buttons 2 and 3 are not caused to correspond to the first and second pointers, respectively, but are caused to correspond to desired random pointers, respectively. Methods of causing the first and second activation buttons 2 and 3 to correspond to the pointers may be various. For example, the first and second activation buttons 2 and 3 may be caused to correspond to the pointers by moving the mouse 1 to positions at which desired pointers are located and clicking the first and second activation buttons 2 and 3 after the pointers are inactivated. Meanwhile, when a plurality of pointers are generated, the remaining pointers except for pointers corresponding to the first and second activation buttons 2 and 3 may be caused to correspond to particular keys of a keyboard For example, pointers may be controlled by causing numeral keys selected by a Num Lock button to correspond to the pointers, respectively. In this case, when a pointer is situated at a position where the user can select a desired function, by the movement of the mouse 1, the user immediately performs a function by clicking a numeral key corresponding to the pointer. That is, the user knows that the pointers of the mouse 1 are activated, and a desired function may be performed by selecting a numeral key corresponding to any of the pointers.

As the mouse 1 is moved, the position detecting unit 9 for detecting the position of the pointer detects the current position of the pointer using a ball or light In the present invention, the movement of the mouse 1 is detected so as to detect the position of a currently activated pointer. Information on the movement of the mouse 1 is provided to the driver 10, and the driver 10 calculates the position of a selected pointer using detection results provided by the position detecting portion 9.

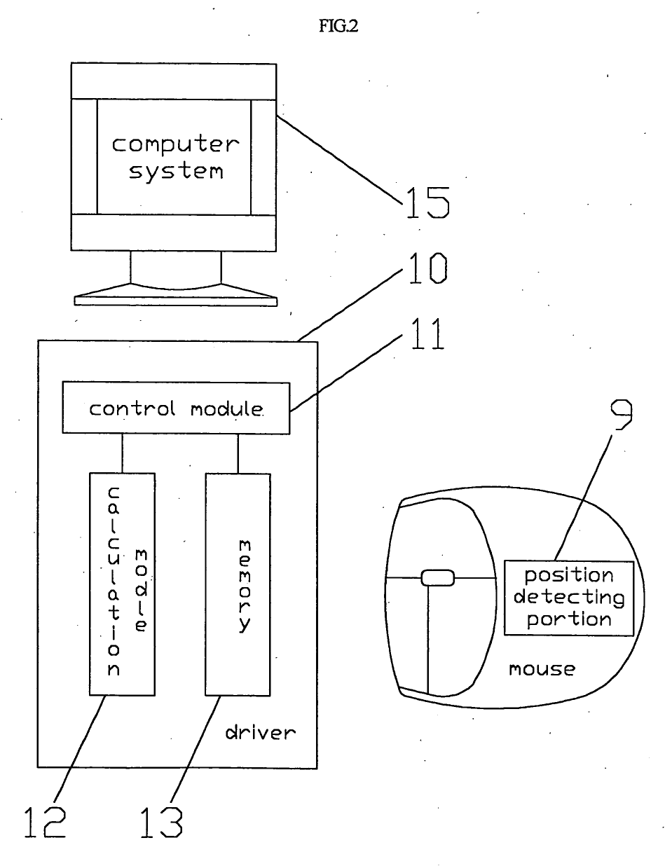

Accordingly, the driver 10, as shown in FIG. 2, includes a calculation module 12 for calculating the position of each pointer using detection results provided by the position detecting portion 9, a memory 13 for storing information on the position of the pointer, and a control module 11 for retrieving the information on the position of the pointer selected by the activation buttons, the generation button 7 and the holding button 5 from the memory 13, providing the information on the position of the pointer to the calculation module 12, and providing calculation results obtained by the calculation module 12 to the computer system 15. In this case, the calculation module 12 obtains calculation results in coordinate form by adding/subtracting the moving distance of the pointer detected by the position detecting portion 9 to/from the position of the pointer stored in the memory 13, and provides the calculation results to the computer system 15. The computer system 15 moves the pointer according to the calculation results obtained by the calculation results.

A process of employing particular programs through the use of the mouse 1 having the above-described construction is described below.

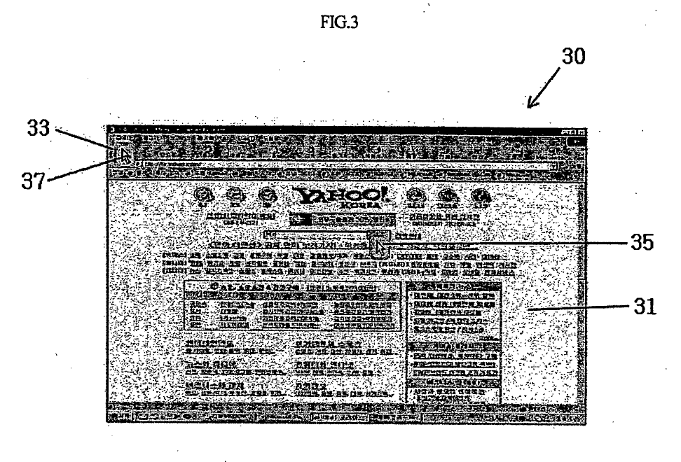

First, a case of using the mouse 1 of the present invention to search the Internet is described as an example. Generally, an Internet user accesses a particular site, accesses a search site to collect desired information and performs mail work using a Web browser. When the Internet user desires to move to a previous page or previously accessed Web site while accessing the Internet, he uses a “back” button on the Web browser. The “back” button may be considered as a frequently used button on the Web browser. In this case, for the Internet user to click the “back” button while using the Internet, a pointer located at a position on a Web page has to be moved to the “back” button, which is inconvenient To this end, as shown in FIG. 3, the user may generate the second pointer 37 separately from the first pointer 35, locate the second pointer 37 on the “back” button, and use the second pointer 37.

In order to generate the second pointer 37, the mouse 1 is moved from the position of the first pointer 35 with the generation button 7 of the mouse 1 being pressed. At this time, the moving path of the mouse 1 is displayed. When the mouse 1 reaches the “back” button along the moving path of the mouse 1, the user releases the generation button 7 from a pressed state. Then, the second pointer 37 is generated at the position of the “back” button. In order to hold the second pointer 37 at the position of the “back” button, the holding button 5 is clicked without the movement of the mouse 1. Then, the second pointer 37 is held on the position of the “back” button. In this case, the first pointer 35 is activated and becomes selectable by the first activation button 2, and the second pointer 37 is activated and becomes selectable by the second activation button 3.

Furthermore, the second pointer 37 held by the holding button 5 can be easily moved using the generation button 7.

For example, when the mouse 1 is moved with the generation button 7 being pressed after the second pointer 37 is generated and held at a certain position, the second pointer 37 is moved along with the mouse 1. When the generation button 7 is released from a pressed state, the second pointer 37 is re-held at the position where the generation button 7 is released from the pressed state. It is desirable to prevent the first pointer 35 from being moved while the second pointer 37 is moved with the generation button 7 being pressed. This manner is advantageous to the detection of the position of the first pointer 35.

Accordingly, the user can change the held position of the second pointer 37 by moving the generation button 7 while pressing the generation button 7 without moving and holding the second pointer 37 after pushing the holding button 5 and therefore releasing the second pointer from a held state.

When the user moves the mouse 1 with the first and second pointers 35 and 37 being set, the position detecting portion 9 of the mouse 1 provides information on the moving distance of the mouse 1 to the driver 10. The calculation module 12 of the driver 10 calculates the position coordinates of the first pointer 35 using the position coordinates of the first pointer 35 retrieved from the memory 13 and the moving distance of the mouse 1 provided by the position detecting portion 9. The calculated position coordinates of the first pointer 35 are provided to the computer system 15 by the control module 11. The computer system 15 changes the position of the first pointer 35, and changes the position of the first pointer 35 through the above-described process whenever the mouse 1 is moved. When the first activation button 2 is clicked, an object on which the first pointer 35 is located is selected, and a picture 31 or window corresponding to the selected object is displayed to show information in the same manner as in the prior art.

In the case where the user desires to see a previous picture while using the Web browser 30, the user clicks only the second activation button 3 without moving the mouse 1. Then, the function of the “back” button is selected by the second pointer 37 held on the “back” button 33, and information on the selection of the function of the “back” button 33 is provided to the computer system 15 through the driver 10. The computer system 15 displays the previous picture on the Web browser 30 according to the selection of the function of the “back” button 33.

In the meantime, when the mouse 1 of the present invention is applied to a word processor, the second pointer 37 is used while being held on a function that is frequently used but has no hot key. For example, in the case where letters are frequently processed using a “bold” function or “underline” function during word processing, the user can conveniently use the “bold” or “underline” function while holding the second function 37 on the “bold” or “underline” function. Additionally, when the user desires to select various functions such as the “bold” and “underline” functions, the user may generate pointers at the positions of function buttons using the generation button 7 and select pointers using a keyboard. Accordingly, when the mouse 1 of the present invention is applied to a word processor, functions may be easily selected.

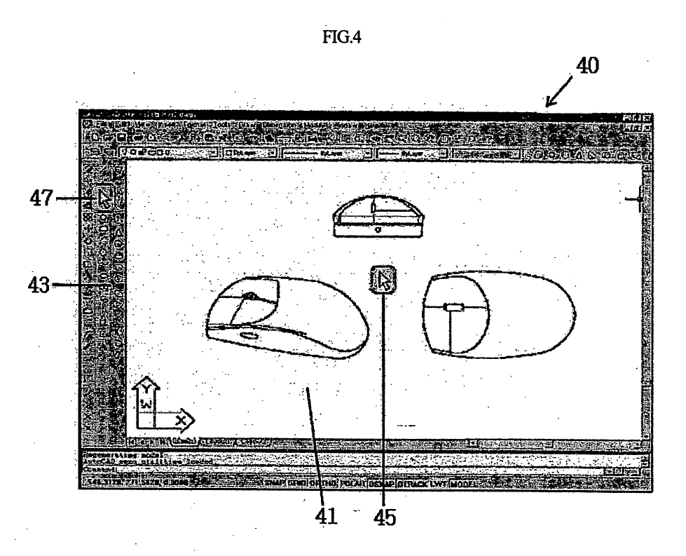

Furthermore, when a graphic or Computer Aided Design (CAD) operation is performed, an effort to move between a work area 41 and a tool area 43 may be reduced by locating one of the first and second pointers 45 and 47 on the work area 41 and the other on the tool area 43, as shown in a CAD window 41 of FIG. 4.

For game programs, games may be made to be effectively operated by locating the first and second pointers 45 and 47 on frequently used functions or areas, and selecting and moving the first and second pointers 45 and 47 at the same time or separately.

As described above, the mouse 1 of the present invention improves a user's convenience by generating pointers of a number corresponding to desired positions and a desired number and allowing the pointers to be moved at the same time or separately. Additionally, unlike the prior art, the inconvenience of repeatedly moving the mouse 1 vertically and horizontally is eliminated by holding a pointer on a particular function and allowing the function on which the pointer is held to be selected at the time of selecting the pointer. Furthermore, when the user performs an operation thorough one of various programs, the distance the user has to move the mouse 1 is significantly reduced, so operating time is reduced, thus improving operating efficiency. Additionally, it will be easily appreciated that a physical exertion to the user is significantly reduced by the mouse 1 of the present invention.

### INDUSTRIAL APPLICABILITY

As described above, the present invention provides an input device for a computer system, which is capable of reducing a moving distance of a mouse, so operating time and a physical exertion to a user are reduced, thus improving operating efficiency and user's convenience.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. An input device for a computer system, the input system having a mouse with a plurality of pointers and a keyboard, comprising:
one or more activation selecting portions for activating at least one of the pointers of the mouse;
a generation selecting portion for selecting generation of at least one pointer;
a position detecting portion mounted on a side of the mouse to detect movement of the mouse; and
a driver for activating and generating the pointer in response to selection of the activation selecting portions and the generation selecting portion, respectively, and controlling movement of the pointer in response to detection results output from the position detecting portion.

2. The input device as set forth in claim 1, further comprising a hold selecting portion for preventing movement of the selected pointer and enabling selection of an object at which the selected pointer is located.

3. The input device as set forth in claim 2, wherein as the mouse is moved, a plurality of pointers generated by the generation selecting portion are moved together.

4. The input device as set forth in claim 1, wherein the driver transmits signals from the mouse to the computer system and from the computer system to the mouse, and comprises:
a memory for storing information on a position of each pointer;
a calculation module for calculating a current position of each pointer using the information on the position of each pointer stored in the memory and detection results provided by the position detecting portion; and
a control module for retrieving information on a position of a pointer selected by the activation selection portions, the generation selecting portion and the hold selecting portion from the memory, providing the information on the position of the pointer to the calculation module, and providing calculation results obtained by the calculation module to the computer system.

5. The input device as set forth in claim 4, wherein the activation selecting portions comprise first and second activation buttons that each function to activate selected one of the pointers and are formed on a portion of a top of the mouse.

6. The input device as set forth in claim 5, wherein the calculation module calculates a current position of a pointer selected by one of the first and second activation buttons and provides information on the calculated current position to the computer system.

7. An input device for a computer system, the input system having a mouse with a plurality of pointers and a keyboard, comprising:
one or more activation selecting portions for activating at least one of the pointers of the mouse;
a hold selecting portion for preventing movement of a selected pointer and enabling selection of an object at which the selected pointer is located;
a position detecting portion mounted on a side of the mouse to detect movement of the mouse; and
a driver for activating and generating the pointer in response to selection of the activation selecting portions and the generation selecting portion, respectively, and controlling movement of the pointer in response to detection results output from the position detecting portion.

8. The input device as set forth in claim 6 or 7, wherein:
if the mouse is moved with the generation selecting portion being pressed, the pointer held by selection of the hold selecting portion is moved along a moving path of the mouse;
if the generation selecting portion is released from a pressed state, the held pointer is re-held at a position where the releasing occurs; and
remaining pointers except for the held pointer are not moved while the mouse is moved with the generation selecting portion being pressed.
